(19) United States
(12) Patent Application Publication
(10) Pub. No.: US 2023/0162681 A1
(43) Pub. Date: May 25, 2023

(54) DISPLAY, METHOD, AND 5T1C N-TYPE PIXEL CIRCUIT

(71) Applicant: Ignis Innovation Inc., Waterloo (CA)

(72) Inventors: Masih BAHRANI, Waterloo (CA); Raymond LEERENTVELD, Palgrave (CA)

(21) Appl. No.: 18/058,757

(22) Filed: Nov. 24, 2022

Related U.S. Application Data
(60) Provisional application No. 63/282,982, filed on Nov. 24, 2021.

(51) Int. Cl. G09G 3/3233; G09G 3/20

(52) U.S. Cl. CPC G09G 3/3233; G09G 3/2096; G09G 2300/0842; G09G 2300/0819; G09G 2310/08; G09G 2300/0861

(57) ABSTRACT

Active Matrix Organic Light-Emitting Diode (AMOLED) displays, novel pixel circuits therefore, and methods of programming and driving the pixel circuit are disclosed. A pixel circuit includes five TFT transistors, a light-emitting device and a storage capacitor coupled to an external voltage supplied through a voltage line and is driven using a plurality of operation states effecting in-pixel compensation.

### CROSS-REFERENCE TO RELATED APPLICATION

This application claims the benefit of U.S. Provisional Application No. 63/282,982, filed Nov. 24, 2021, which is hereby incorporated by reference herein in its entirety.

### FIELD OF THE PRESENT DISCLOSURE

The present disclosure relates to active-matrix organic light-emitting diode (AMOLED) displays and particularly to pixel circuits thereof and methods of driving pixel circuits to emit light.

### BRIEF SUMMARY

According to a first aspect there is provided a display system including: an array of pixel circuits arranged in rows and columns, a pixel circuit of the array of pixel circuits including: a drive transistor coupled between a first and a second supply voltage and including a source terminal coupleable to a data line of the display system; a storage capacitor coupled across a gate terminal of the drive transistor and a voltage line; and a light-emitting device coupled between the first supply voltage and the source terminal of the drive transistor, and a controller for driving the pixel circuit in a drive mode including a plurality of operation states for the pixel circuit including a programming and in-pixel compensation state at least for programming the storage capacitor of the pixel circuit with use of a data voltage provided over the data line.

In some embodiments, the voltage line is kept at a constant voltage level.

In some embodiments, the constant voltage level is a voltage level different from voltage levels of the first and the second supply voltages.

Some embodiments further provide for an initialization transistor coupled across a drain terminal and the gate terminal of the drive transistor.

In some embodiments, the initialization transistor is for coupling the gate and drain terminals of the drive transistor during an initialization state.

In some embodiments, the initialization transistor is for coupling the gate and drain terminals of the drive transistor during a programming and in-pixel compensation state, in which the drive transistor discharges a gate voltage of the gate terminal until the drive transistor turns off.

Some embodiments further provide for a first emission transistor coupled between the first supply voltage and the drain terminal of the drive transistor and a second emission transistor coupled between the source terminal of the drive transistor and the second supply voltage, the first and second emission transistors for allowing current to pass between the first and second supply voltages and though the light-emitting device during an emission state.

Some embodiments further provide for a write transistor coupled between the source terminal of the drive transistor and the data line, for said programming the storage capacitor with use of the data voltage during the programming and in-pixel compensation state.

In some embodiments, the pixel circuit includes transistors which are only N-type TFTs, and said light-emitting device is an organic light-emitting diode (OLED) device.

According to another aspect there is provided a method of driving a display system, the display system including an array of pixel circuits arranged in rows and columns, a pixel circuit of the array of pixel circuits including: a drive transistor coupled between a first and a second supply voltage and including a source terminal coupleable to a data line of the display system; a storage capacitor coupled across a gate terminal of the drive transistor and a voltage line; and a light-emitting device coupled between the first supply voltage and the source terminal of the drive transistor, the method comprising: driving the pixel circuit in a plurality of operation states for the pixel circuit including: during a programming and in-pixel compensation state, programming the storage capacitor of the pixel circuit with use of a data voltage provided over the data line.

In some embodiments, during the plurality of operation states the voltage line is kept at a constant voltage level.

In some embodiments the constant voltage level is kept at a voltage level different from voltage levels of the first and the second supply voltages.

In some embodiments, the display system includes an initialization transistor coupled across a drain terminal and the gate terminal of the drive transistor, and driving the pixel circuit in the plurality of operation states further includes: during an initialization state, coupling the gate and drain terminals of the drive transistor with the initialization transistor.

In some embodiments, driving the pixel circuit in the plurality of operation states further includes: during the programming and in-pixel compensation state, using the initialization transistor to couple the gate and drain terminals of the drive transistor allowing the drive transistor to discharge a gate voltage of the gate terminal until the drive transistor turns off.

In some embodiments, the display system includes a first emission transistor coupled between the first supply voltage and the drain terminal of the drive transistor and a second emission transistor coupled between the source terminal of the drive transistor and the second supply voltage, and driving the pixel circuit in the plurality of operation states further includes: during an emission state turning the first and second emission transistors on to allow current to pass between the first and second supply voltages and though the light-emitting device.

In some embodiments, the display system includes a write transistor coupled between the source terminal of the drive transistor and the data line, and driving the pixel circuit in the plurality of operation states further includes: during the programming and in-pixel compensation state, using the write transistor to program the storage capacitor with use of the data voltage.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 is a schematic block diagram of an example active-matrix display system in accordance with an embodiment.

FIG. 2 is a schematic circuit diagram of an embodiment of a pixel circuit for the display of FIG. 1, the pixel circuit including five TFT transistors, a light-emitting device, and a capacitor.

FIG. 3 is an example timing diagram of control signals for the pixel circuit in a drive mode.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

An Organic Light-Emitting Diode (OLED) device is a light-emitting device in which the emissive electroluminescent layer is a film of organic compound that emits light in response to an electric current. This layer of organic material is situated between two electrodes; typically, at least one of these electrodes is transparent. Compared to conventional Liquid Crystal Displays (LCDs), Active Matrix Organic Light Emitting Device (AMOLED) displays offer lower power consumption, manufacturing flexibility, faster response time, larger viewing angles, higher contrast, lighter weight, and amenability to flexible substrates. An AMOLED display works without a backlight because the organic material of the OLED within each pixel itself emits visible light and each pixel consists of different colored OLEDs emitting light independently. The OLED panel can display a deep black level and can be thinner than an LCD display. The OLEDs emit light according to currents passing through them supplied through drive transistors controlled by programming voltages. The power consumed in each pixel has a relation with the magnitude of the generated light in that pixel.

The quality of output in an OLED-based pixel depends on the properties of the drive transistor, which is typically fabricated from materials including but not limited to amorphous silicon, polysilicon, or metal oxide, as well as properties of the OLED itself. In particular, the critical drawbacks of OLED displays include luminance non-uniformity due to the electrical characteristic variations of the drive transistor such as threshold voltage and mobility as the pixel ages and image sticking due to the differential aging of OLED devices. In order to maintain high image quality, variation of these parameters are compensated for by adjusting the programming voltage. In some approaches, those parameters are extracted from the driver circuit. The measured information can then be used to inform subsequent programming of the pixel circuits so that adjustments may be made to the programming taking into account the measured degradation. In some approaches, in-pixel compensation which adjusts the programming voltage in-pixel taking into account the degradation of that pixel is utilized.

Aspects of the present disclosure include a novel pixel circuit in display panels and methods to drive the pixel in ways which take into account the parameters of the pixel which affect performance. The pixel circuit includes a light-emitting device, such as an Organic Light Emitting Diode (OLED), a storage capacitor and Thin Film Transistors (TFTs). Methods include supplying voltage or current to the pixel circuit from the source via the data line over a number of cycles or states such that in-pixel programming is compensated, at least in part, for degradation of the pixel.

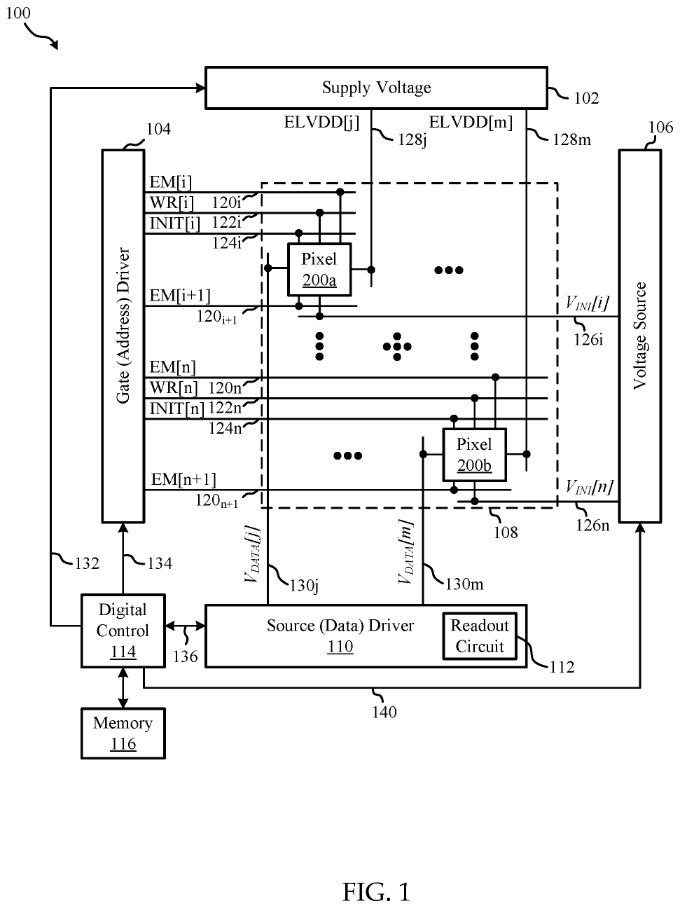

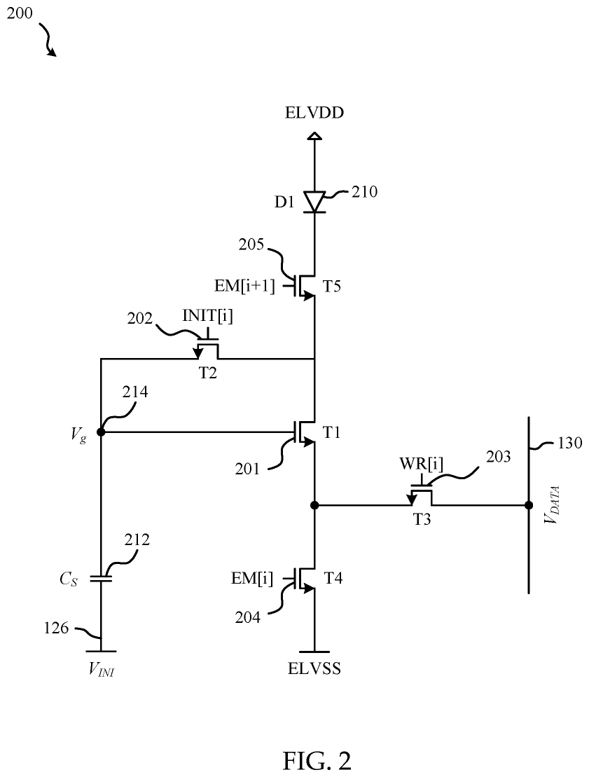

FIG. 1 is a block diagram of an exemplary display system 100 according to an embodiment. The display system 100 includes a display panel 108, a source driver 110 which may include a Readout Circuit (ROC) 112, a gate driver 104, a controller 114, a memory storage 116, a voltage source 106, and a supply voltage 102. The display panel 108 includes a plurality of pixels 200 arranged in “n” rows and “m” columns. Each pixel 200 has a pixel circuit including five Thin Film Transistors (TFTs), a storage capacitor and a light-emitting device as shown in FIG. 2. Each pixel 200 is individually programmed to emit light with specific luminance values. The digital controller 114 receives digital video data indicative of information to be displayed on the display panel 108. The controller 114 sends signals 136 comprising digital video data to the source driver 110 and signals 134 to the gate (address) driver 104 to drive the pixels 200 in the display panel 108 on a row-by-row basis to display the information indicated. The plurality of pixels 200 associated with the display panel 108 thus comprise a display array (“display screen”) adapted to dynamically display information according to the input digital data received by the controller 114. The display screen 108 can display, for example, video information from a stream of video data (not shown) received by the controller 114. The supply voltage 102 provides constant or adjustable supply voltages (e.g. ELVDD) for the display panel 108 which is controlled by the signals 132 from the controller 114. The voltage source 106 provides constant voltage V_{INI} for the display panel 108 which is controlled by the signals 140 from the controller 114.

FIG. 1 is illustrated with only two pixels 200a and 200b in the display panel 108 for sake of simplicity and illustration. The display system 100 can be implemented with a plurality of similar pixels, such as the pixel 200 and the display panel size is not restricted to a particular number of rows and columns of pixels. For example, the display system 100 can be implemented with a display panel with a number of rows and columns of pixels commonly available in displays for mobile devices, monitor-based devices, TVs, and projection devices. FIG. 1 is illustrated with only two pixels 200a and 200b in the display panel 108.

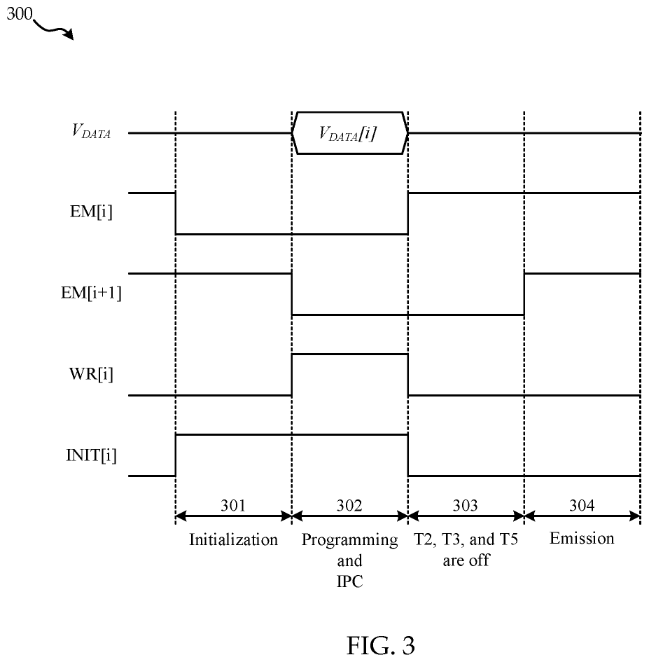

As shown in FIG. 1, the pixel 200a illustrated as the top-left pixel in the display panel 108 represents a “ith” row and “jth” column pixel and is coupled to an emission signal line 120i for a first emission signal EM[i] and the emission signal line 120ᵢ₊₁ of the next row for the second emission signal EM[i+1] which is the first emission signal of the next row, coupled to a write signal line 122i for a write signal WR[i], a initialization signal line 124i for an initialization signal INIT[i], coupled to a supply line 128j for a supply voltage ELVDD[j], coupled to a data line 130j for a data voltage V_{DATA}[j], and coupled to a voltage line 126i for a voltage V_{INI}[i]. The pixel 200b illustrated as the bottom-right pixel 200 in the display panel 108 represents a “nth” row and “mth” column pixel and is coupled to an emission signal line 120n for a first emission signal EM[n] and to an emission signal line 120ₙ₊₁ for a second emission signal EM[n+1] (delayed by one programming cycle from EM[n], e.g. see FIG. 3), coupled to a write signal line 122n for a write signal WR[n], coupled to an initialization signal line 124n for an initialization signal INIT[n], coupled to a supply line 128m for a supply voltage ELVDD[m], coupled to a data line 130m for a data voltage V_{DATA}[m], and coupled to a voltage line 126n for a voltage V_{INI}[n].

As shown in FIG. 1, the gate driver 104 provides the EM, WR, and INIT signals for the emission signal lines 120i, 120n, 120ᵢ₊₁, 120ₙ₊₁, the write signal lines 122i, 122n, and the initialization signal lines 124i, 124n. These signals are utilized to control the pixels 200 in the display panel 108 in order to program and drive the pixels 200. The data line 130 conveys programming information such as a programming voltage V_{DATA} to the pixel 200 from the source driver 110 to the pixel 200 in order to program the pixel 200 to emit a desired amount of luminance according to the digital data received by the controller 114. The programming voltage can be applied to the pixel 200 during a programming operation of the pixel 200 so as to charge a storage device within the pixel 200, such as a storage capacitor, thereby enabling the pixel 200 to emit light with the desired amount of luminance during an emission operation following the programming operation. For example, the storage device in the pixel 200 can be charged during a programming operation to keep the data voltage and then apply it to a gate terminal of the driving transistor during the emission operation, thereby causing the driving transistor to convey the driving current through the light-emitting device according to the voltage stored on the storage device. In some embodiments a programming operation is combined with in-pixel compensation.

Generally, in the pixel 200, the driving current that is conveyed through the light-emitting device by the driving transistor during the emission operation of the pixel 200 is a current that is supplied by the supply line (e.g. the supply line 128j and 128m). The supply line 128 can provide a positive supply voltage (e.g., the voltage commonly referred to in circuit design as “ELVDD”). In some implementations, a zero (0V) or negative supply voltage ELVSS[j] can be provided over a second supply line to the pixel 200. For example, as described in association with FIGS. 2 and 3, each pixel can be coupled to a first supply line 128 coupled to ELVDD and a second supply line (not shown) coupled to ELVSS, and the pixel circuits 200 can be situated between the first and second supply lines to facilitate driving current between the two supply lines during emission or other states of the pixel circuit. Although ELVDD and ELVSS may be provided on a column-by-column basis, in some embodiments ELVDD and ELVSS are each single common voltage values provided to all pixels of all columns.

According to an embodiment, an exemplary pixel circuit 200 of a display system of FIG. 1, is shown in FIG. 2, the pixel circuit comprising five N-type TFTs (T1, T2, T3, T4 and T5) 201 202 203 204 205, a light-emitting device (D1) 210 (such as an OLED), a storage capacitor (C_{S}) 212, and input with four control signals. A drive transistor T1 201 is coupled in series with the light-emitting device D1 210, and the storage capacitor (C_{S}) 212 is coupled across a gate 214 of the drive transistor T1 201 and a voltage line 126 providing the voltage V_{INI}. Transistor T4 204, controlled by the first emission signal EM[i], is coupled between the source of the drive transistor T1 201 and ELVSS. Transistor T3 203, controlled by the write signal WR[i], is coupled between the source of the drive transistor T1 201 and the data line 130, while transistor T2 202, controlled by the initialization signal INIT[i], is coupled between the gate of the drive transistor T1 201 and the drain of the drive transistor T1 201. Transistor T5 205, controlled by the second emission signal EM[i+1] is coupled between the drain of the drive transistor T1 201 and the light-emitting device D1 210.

Control signals EM[i], WR[i], and INIT[i] are control signals of a pixel circuit 200 of the ith row. The second emission signal EM[i+1] is the first emission signal for the (i+1)th row and is also coupled to the ith row. As will be seen in FIG. 3, the EM[i+1] lags behind EM[i] by the duration of one operation cycle or state. All the control signals are provided by the gate driver 104, as controlled by the controller 114, as shown in FIG. 1.

The constant voltage V_{INI} is common for all pixels located in each row. These voltages V_{INI}[i] . . . V_{INI}[n] are provided over voltage lines 126i . . . 126n by the voltage source 106. In some embodiments, a common voltage V_{INI} is common to and provided for all pixels in all rows. The pixel circuit 200 includes a storage capacitor Cₛ 212, for storing a voltage including a data voltage V_{DATA} provided by the source driver 110 over the data line 130 and for allowing the pixel circuit 200 to drive the light-emitting device D1 210 after being addressed. As such, the display panel 108 including a pixel circuit 200, is an active-matrix display array. The present disclosure includes a novel pixel circuit in display panels which includes the N-type TFT transistors because the N-type TFT transistors have far less threshold voltage variation than their p-type TFT transistor counterparts. Therefore, time for the programming and In-Pixel Compensation (IPC) state (referred to below) can be reduced in order to reduce the total time for the driving mode described below. Although, the transistors utilized in the pixel circuit 200 are N-type Thin Film Transistors (TFTs), implementations of the present disclosure are not limited to pixel circuits having a particular polarity of transistor or only to pixel circuits having thin-film transistors.

In some embodiments, the display system 100 also includes a Readout Circuit (ROC) 112 which is integrated with the source driver 110. The data line (130j, 130m) connects the pixel 200 to the readout circuit 112. The data line (130j, 130m) allows the readout circuit 112 to measure an electrical signals (voltage or current) associated with the pixel 200 and thereby extract information indicative of a degradation of the pixel 200. The Readout circuit 112 converts the associated current into a digital value which is sent to the digital control 114 for further processing or compensation.

### Drive Mode

A timing diagram for the control signals of the pixel circuit 200 in the drive mode 300 is shown in FIG. 3. The drive mode 300 of FIG. 3 comprises four states which include, initialization 301, programming and an In-Pixel Compensation (IPC) state 302, an off state 303, and an emission state 304 during which the pixel emits light.

During the initialization state 301, the first emission signal EM[i] is pulled low and the write signal WR[i] is kept low, causing transistor T3 203 to stay off and transistor T4 204 to turn off, while the second emission signal EM[i+1] is kept high and the initialization signal INIT[i] is pulled high, causing transistor T5 205 to stay on and transistor T2 202 to turn on. Consequently, during the initialization state 301, the storage capacitor Cₛ 212 is charged to ELVDD−V_{THLED}−V_{INI}, where V_{THLED} is the threshold voltage of the light emitting diode D1 210 (i.e. the voltage required to turn on, and hence for current to flow through, the light-emitting device D1 210). Moreover, the voltage V_{g} at the gate of the drive transistor T1 201 is charged to ELVDD−V_{THLED}.

During the programming and In-Pixel Compensation (IPC) state 302, the first emission signal EM[i] stays low and the second emission signal EM[i+1] is pulled low, causing transistor T4 204 to stay off and transistor T5 205 to turn off, while the initialization signal INIT[i] is kept high and the write signal WR[i] is pulled high, causing transistor T2 202 to stay on and transistor T3 203 to turn on. The appropriate V_{DATA}[i] for the pixel circuit 200 is also provided on the data line 130. Consequently, the voltage V_{g} at the gate 214 of the drive transistor T1 201 discharges to V_{DATA}+V_{THT1}, where V_{THT1} is the threshold voltage of the drive transistor T1 201, at which point the drive transistor T1 201 turns off, and the voltage stored in the capacitor Cₛ will have dropped to V_{DATA}+V_{THT1}−V_{INI}.

During the off state 303, the first emission signal EM[i] is pulled high causing transistor T4 204 to turn on, while the second emission signal EM[i+1] stays low, the initialization signal INIT[i] and the write signal WR[i] are pulled low, keeping transistor T5 205 off, while, causing transistors T2 202 and T3 203 to turn off. Consequently, all the transistors except for T4 204 are off.

During the emission state 304, the first emission signal EM[i] stays high and the second emission signal EM[i+1] is pulled high, causing transistor T4 204 to stay on and transistor T5 205 to turn on, while the initialization signal INIT[i] and the write signal WR[i] are kept low, keeping transistors T2 202 and T3 203 off. Consequently, the gate-source voltage at the drive transistor T1 201 is:

V_{gs}=V_{DATA}+V_{THT1}−ELVSS

The drive transistor T1 201 drives the light-emitting device D1 210 with a pixel current Iₚᵢₓₑₗ corresponding to the gate-source voltage Vgs and the characteristics of the drive transistor T1 201. The current passing through the drive transistor T1 201 (and also through the light-emitting diode D1 210) is:

$${I}_{p i x e l} = \frac{1}{2} μ {C}_{o x} ( \frac{W}{L} ) {( {V}_{DATA} - ELVSS )}^{2}$$

where μ is the charge carrier mobility, Cₒₓ is the oxide capacitance density, W/L is the width to length ratio of the drive transistor T1 201. Hence, both the current passing through the pixel 200 and the luminance of the light-emitting device are independent of the threshold voltage V_{THT1} of the drive transistor T1 201.

Although the embodiments have been described with functionality of the transistors resulting from the application of particular example voltage values such as “ELVDD” or “0” or “ELVSS”, it is to be understood that in different contexts, the application of “high” and “low” voltages of appropriate different voltage values may be used to effect the same functionality from transistors and do not represent a departure from the embodiments disclosed above.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A display system comprising:
an array of pixel circuits arranged in rows and columns, a pixel circuit of the array of pixel circuits including:
a drive transistor coupled between a first and a second supply voltage and including a source terminal coupleable to a data line of the display system;
a storage capacitor coupled across a gate terminal of the drive transistor and a voltage line;
a light-emitting device coupled between the first supply voltage and the source terminal of the drive transistor, and
a controller for driving the pixel circuit in a drive mode including a plurality of operation states for the pixel circuit including a programming and in-pixel compensation state at least for programming the storage capacitor of the pixel circuit with use of a data voltage provided over the data line.

2. The display system of claim 1, wherein the voltage line is kept at a constant voltage level.

3. The display system of claim 2, wherein the constant voltage level is a voltage level different from voltage levels of the first and the second supply voltages.

4. The display system of claim 2, further comprising an initialization transistor coupled across a drain terminal and the gate terminal of the drive transistor.

5. The display system of claim 4, wherein the initialization transistor is for coupling the gate and drain terminals of the drive transistor during an initialization state.

6. The display system of claim 5, wherein the initialization transistor is for coupling the gate and drain terminals of the drive transistor during a programming and in-pixel compensation state, wherein the drive transistor discharges a gate voltage of the gate terminal until the drive transistor turns off.

7. The display system of claim 6, further comprising a first emission transistor coupled between the first supply voltage and the drain terminal of the drive transistor and a second emission transistor coupled between the source terminal of the drive transistor and the second supply voltage, the first and second emission transistors for allowing current to pass between the first and second supply voltages and though the light-emitting device during an emission state.

8. The display system of claim 7, further comprising a write transistor coupled between the source terminal of the drive transistor and the data line, for said programming the storage capacitor with use of the data voltage during the programming and in-pixel compensation state.

9. The display system of claim 8, wherein the pixel circuit comprises transistors which are only N-type TFTs, and wherein said light-emitting device is an organic light-emitting diode (OLED) device.

10. A method of driving a display system, the display system including an array of pixel circuits arranged in rows and columns, a pixel circuit of the array of pixel circuits including: a drive transistor coupled between a first and a second supply voltage and including a source terminal coupleable to a data line of the display system; a storage capacitor coupled across a gate terminal of the drive transistor and a voltage line; and a light-emitting device coupled between the first supply voltage and the source terminal of the drive transistor, the method comprising:
driving the pixel circuit in a plurality of operation states for the pixel circuit including:
during a programming and in-pixel compensation state, programming the storage capacitor of the pixel circuit with use of a data voltage provided over the data line.

11. The method of claim 10, wherein during the plurality of operation states the voltage line is kept at a constant voltage level.

12. The method of claim 11, wherein the constant voltage level is kept at a voltage level different from voltage levels of the first and the second supply voltages.

13. The method of claim 12, wherein the display system includes an initialization transistor coupled across a drain terminal and the gate terminal of the drive transistor, and driving the pixel circuit in the plurality of operation states further comprises:
during an initialization state, coupling the gate and drain terminals of the drive transistor with the initialization transistor.

14. The method of claim 13, wherein driving the pixel circuit in the plurality of operation states further comprises:
during the programming and in-pixel compensation state, using the initialization transistor to couple the gate and drain terminals of the drive transistor allowing the drive transistor to discharge a gate voltage of the gate terminal until the drive transistor turns off.

15. The method of claim 14, wherein the display system includes a first emission transistor coupled between the first supply voltage and the drain terminal of the drive transistor and a second emission transistor coupled between the source terminal of the drive transistor and the second supply voltage, and wherein driving the pixel circuit in the plurality of operation states further comprises:
during an emission state turning the first and second emission transistors on to allow current to pass between the first and second supply voltages and though the light-emitting device.

16. The method of claim 15, wherein the display system includes a write transistor coupled between the source terminal of the drive transistor and the data line, and wherein driving the pixel circuit in the plurality of operation states further comprises:
during the programming and in-pixel compensation state, using the write transistor to program the storage capacitor with use of the data voltage.

17. The method of claim 16, wherein the pixel circuit comprises transistors which are only N-type TFTs, and wherein said light-emitting device is an OLED device.
